(19) United States
(12) Patent Application Publication
(10) Pub. No.: US 2007/0094731 A1
(43) Pub. Date: Apr. 26, 2007

(54) Integrated functionality for detecting and treating undesirable activities

(75) Inventors: Dan Teodosiu, Kirkland, WA (US); Daniel Gwozdz, Redmond, WA (US); Sean E. Purcell, Seattle, WA (US); Amy Wu, Redmond, WA (US); Alexandra Heron, Redmond, WA (US); Elissa E.S. Murphy, Seattle, WA (US); Bo J. Rohlfsen, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/257,759

(22) Filed: Oct. 25, 2005

(51) Int. Cl. G06F 12/14

(52) U.S. Cl. 726/24

(57) ABSTRACT

Various embodiments provide integrated solutions for detecting and treating undesirable activities. Detection and treatment solutions are integrated with software entities, such as applications, DLLs and the like, and provide status notifications for the user as to the status of the detection and treatment activities. In at least some embodiments, an integrated user interface is provided and gives the user the option to provide input and affect at least some of the treatment options.

### BACKGROUND

Many types of software entities can expose a user to undesirable activities as a result of the user's interaction with the entity. Yet, most if not all of these software entities do not provide an integrated way to deal with the undesirable activity once the user is at or near a point of vulnerability.

### SUMMARY

Various embodiments provide integrated solutions for detecting and treating undesirable activities. Detection and treatment solutions are integrated with software entities, such as applications, DLLs and the like, and provide status notifications for the user as to the status of the detection and treatment activities. In at least some embodiments, an integrated user interface is provided and gives the user the option to provide input and affect at least some of the treatment options.

### BRIEF DESCRIPTION OF THE DRAWINGS

FIG. 1 shows an exemplary system in which the various embodiments described in this document can be implemented in accordance with one embodiment.

FIG. 2 illustrates an exemplary application and user interface in accordance with one embodiment.

FIG. 3 illustrates an exemplary user interface in accordance with one embodiment.

FIG. 4 illustrates an exemplary user interface in accordance with one embodiment.

FIG. 5 illustrates an exemplary user interface in accordance with one embodiment.

FIG. 6 illustrates an exemplary user interface in accordance with one embodiment.

FIG. 7 illustrates an exemplary system in accordance with one embodiment.

FIG. 8 is a flow diagram that describes steps in a method in accordance with one embodiment.

FIG. 9 is a flow diagram that describes steps in a method in accordance with one embodiment.

FIG. 10 is a flow diagram that describes steps in a method in accordance with one embodiment.

### DETAILED DESCRIPTION

Overview

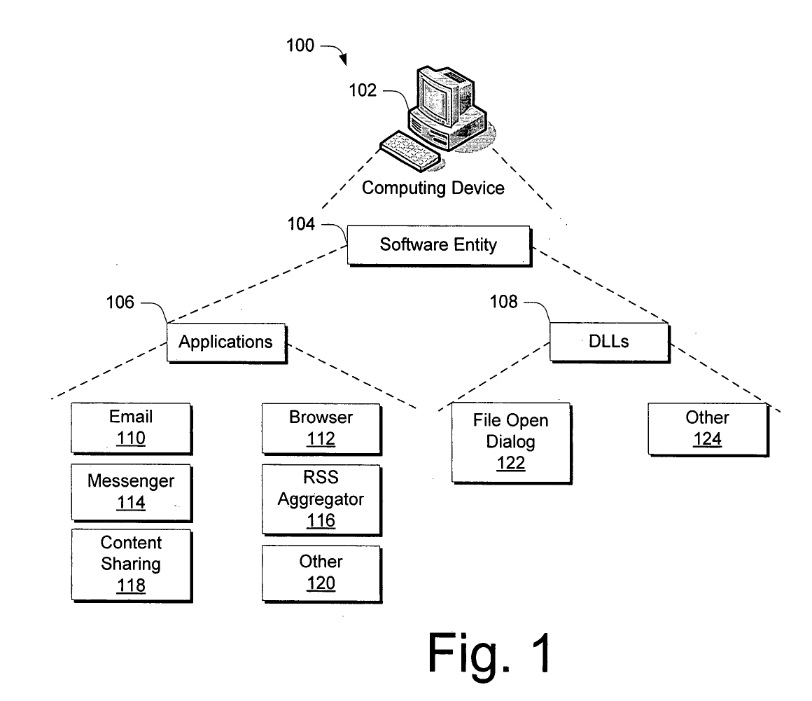

FIG. 1 shows an exemplary system, generally at 100, in which the various embodiments described in this document can be implemented. In this particular example, system 100 includes a computing device 102 which can be any suitable computing device such as a personal or desktop computer, handheld computing device and the like. Such computing devices typically contain one or more processors, one or more computer-readable media, software entities, such as entity 104 that is embodied on the computer-readable media and various other components that impart to the computing device its functionality, as will be appreciated by the skilled artisan.

In the examples given below, various types of software entities can utilize the principles described in this document. For example, software entities such as various applications 106 and/or DLLs 108 can utilize the principles described below. Some types of applications include, by way of example and not limitation, email applications 110, browser applications 112, messenger applications 114, RSS aggregators 116, content sharing applications 118 such as photo-, music- and/or video-sharing applications, as well as a host of other applications 120 which, from a practical standpoint, are too numerous to list. Some types of DLLs that can utilize the principles described in this document include, by way of example and not limitation, file open dialog DLLs 122 which are typically called by various applications to open files, as well as a host of other DLLs 124 which, for the sake of brevity, are not listed here.

One characteristic of applications that can utilize the principles described in this document is that such applications typically provide or otherwise expose a list of items for a user. The items can comprise any suitable items and the list can comprise any suitable type of list. For example, one type of list is a log or a log activity list that can expose log items to a user. Log items might include files that a user has received or sent, email messages that the user has received or sent and the like.

In at least some of the illustrated and described embodiments, the software entity is configured to take steps associated with remedying an undesirable activity and, through user interface that is presented to a user, provide the user with status or state information associated with the remedial action that the software entity either performs or has performed on its behalf. Examples of undesirable activities can include by way of example and not limitation, receiving or otherwise being exposed to malware or spyware, receiving spam, and/or receiving or otherwise being exposed to virus-carrying files, messages, or content. Remedial actions that can be performed by the software entity or on its behalf can include by way of example and not limitation, deleting content, scanning and/or fixing virus-carrying content, and/or providing a user with an option to select one or more remedial activities that are to be performed.

To provide some tangible context for the reader to appreciate how the principles described in this document can be applied, an example is provided below in which an application in the form of a messenger application, such as an instant messenger application, is employed. The undesirable activity that is addressed and treated by the messenger application pertains to receiving potentially virus-carrying files or content. It is to be appreciated and understood that this constitutes but one example and is not to be used to limit application of the claimed subject matter to this particular environment. Rather, as noted above, the principles described in this document can be employed in other contexts without departing from the spirit and scope of the claimed subject matter.

Example User Interface

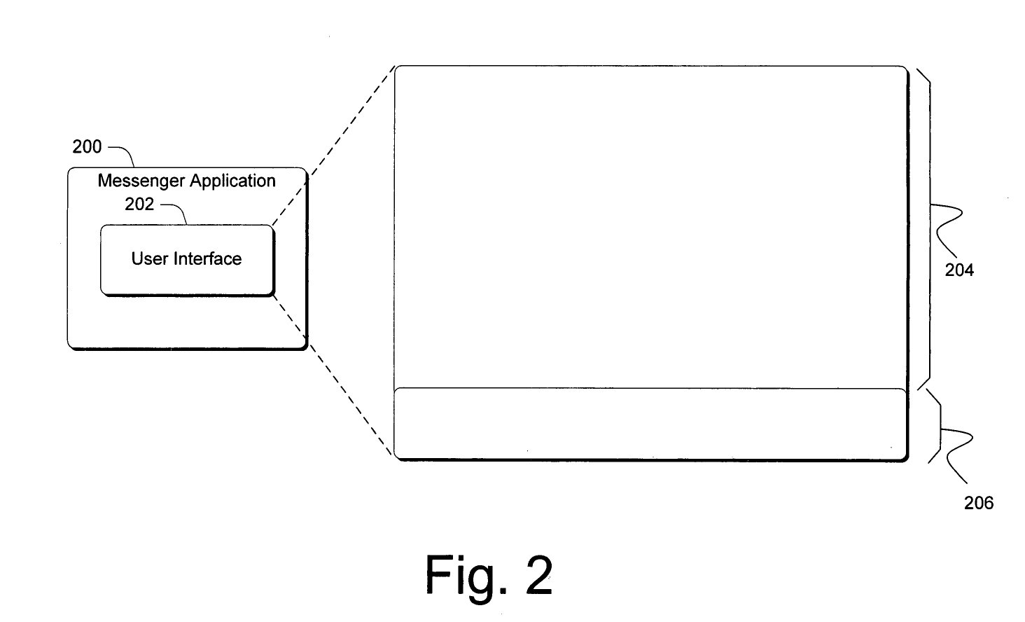

FIG. 2 illustrates one environment in which the principles described in this document can be utilized in accordance with one embodiment. There, an application in the form of a messenger application 200 includes, among other components, a user interface component 202. Messenger application 200 embodies functionality that enables a user to communicate with others across a network such as the Internet. As the basic functionality of messenger applications is known to the skilled artisan, such is not described in additional detail here.

In accordance with one embodiment, user interface component 202 presents to the user a user interface that has multiple different portions. In this particular example, the user interface has two portions-a primary portion 204 that can be considered as being dedicated to at least some messenging or file sharing functionality provided by the messenger application, and a secondary or ancillary portion 206 which includes at least a portion that is dedicated to activity logging and to anti-virus scanning functionality. Secondary or ancillary portion 206 can also include user interface elements that are associated with a messenging functionality.

More generally, in this example as well as others in which the application is different from the specifically illustrated one, the application (i.e. the messenger application) can be considered as one that is not primarily concerned with an anti-virus scanning functionality. Rather, the application is primarily concerned with providing messenging functionality for the user. In this regard, the application is configured to provide a user interface experience that is not primarily associated with anti-virus scanning or, more generally, remedying an undesirable activity. So, in this example, content that is primarily associated with a messenging functionality is presented to the user in portion 204, and content that is associated with activity logging and anti-virus scanning activities can be presented to the user in portion 206.

With respect to the content that can be presented to the user that pertains to activity logging and anti-virus scanning activities, consider the following.

Such content can include state or status information that informs the user as to the state or status of scanning activities. For example, consider that user interface portion 206 is utilized to display a list of items that have been messaged to the user. Such list, which might be considered as a normal part of the messaging application, can include portions that provide the status on whether such items have been scanned or not, and if scanned, the status of the items (i.e. either safe or infected).

Alternately or additionally, user interface portion 206 can provide user interface elements that enable the user to interact in some way with the anti-virus functionality. For example, a user can be given an option to scan particular files and/or to fix or delete infected files. An example of this is provided below in the section entitled “Implementation Example”.

### IMPLEMENTATION EXAMPLE

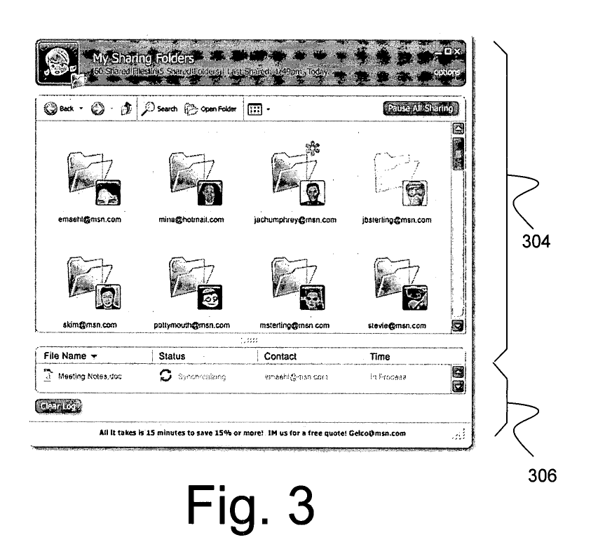

FIG. 3 illustrates an exemplary user interface in accordance with one embodiment. In this example, like numerals from the FIG. 2 example have been utilized to indicate like elements, except that the numerals are now prefixed with a “3”.

Accordingly, the FIG. 3 user interface includes a primary portion 304 and a secondary or ancillary portion 306. In this example, the user interface pertains to folder or file sharing functionality provided by messenger application 200 (FIG. 2).

Specifically, using the folder or file sharing functionality, users can set up so-called replicating “Sharing Folders” with one another in order to share and edit files. In some embodiments, sharing can take place on a one-to-one basis, one-to-many basis or many-to-many basis (also referred to as a circle-share). So, in this particular implementation example, a user can create a “Sharing Folder” with a contact on his or her Messenger list, and the contact will receive an invitation to accept/decline the Sharing Folder. Once both users have set up the Sharing Folder with each other, they will have equal read/write access to it, and any file that they add, edit, or delete will be propagated to the other side. The Sharing Folders on both sides will always remain in-sync, so long as both users are signed into the Messenger service.

Accordingly, FIG. 3 shows a Messenger user interface that renders a Sharing Folder. In the primary portion 304, individual icons are shown and represent those other users with which a sharing relationship exists. Secondary portion 306 provides an activity or sharing log that includes information on all the files that have been replicated, both for new files and for files that have been modified. In addition, the log includes the following columns: a file name column that lists the name of the file, a status column that describes the particular status of a file, a contact column that includes the contact or individual associated with a particular replicated file, and a time column that includes a time associated with when a particular activity pertaining to a file took place. In this particular example, there is one file—Meeting_Notes.doc whose status is represented as “Synchronizing”.

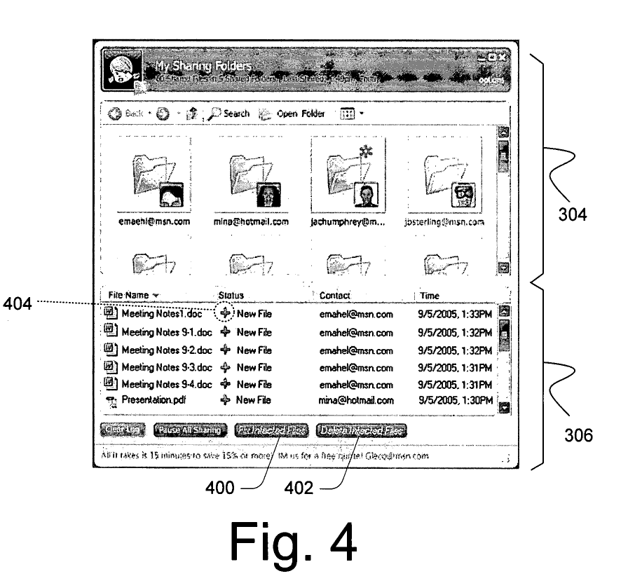

FIG. 4 illustrates the FIG. 3 user interface in which all files have been scanned and checked for viruses and have been found to be clean. Notice in this example, that there are a number of user interface elements individual ones of which being indicated at 400 and 402. Here, the user interface elements enable a user to select a particular remedial action that is to be applied in the event one of the files is found to be infected. Specifically, user interface element 400 allows a user to opt to have a particular infected file, or all infected files, fixed, or at least for a particular fix to be attempted. User interface element 402 allows the user to opt to have a particular infected file, or all infected files, deleted. As such, in this embodiment, the user is given an option to get involved with or drive the remedial actions that are employed.

Notice also that visual indicia, indicated at 404, is provided to show the user that the particular files are safe.

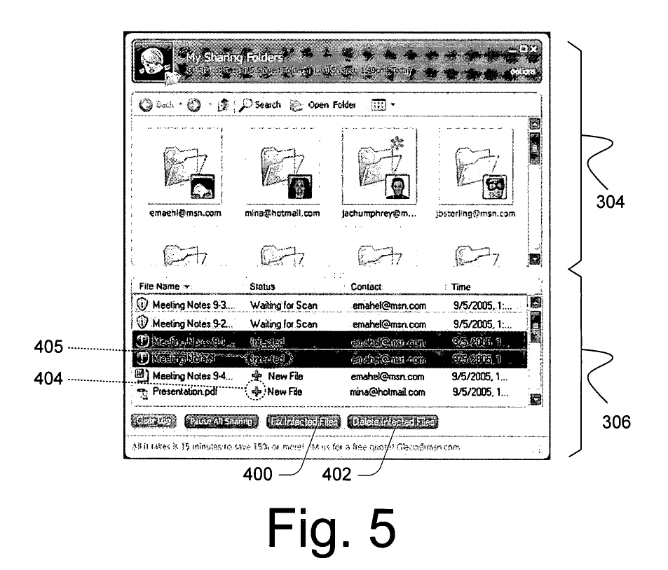

FIG. 5 shows the FIG. 3 user interface in which two of the files (the top two files) in the secondary portion 306 are waiting to be scanned, two files (the middle two files) have been found to be infected, and two files (the bottom two files) have been found to be clean. Visual indicia, indicated at 405, are provided to show the user that the particular files are infected. Notice here that the user can select a particular infected file or set of files and then through selecting the appropriate user interface element 400, 402, have the appropriate remedial action applied. Alternatively, if the user does not select any particular infected file, the appropriate remedial action is applied to all infected files when the user interface element 400 or 402 is selected.

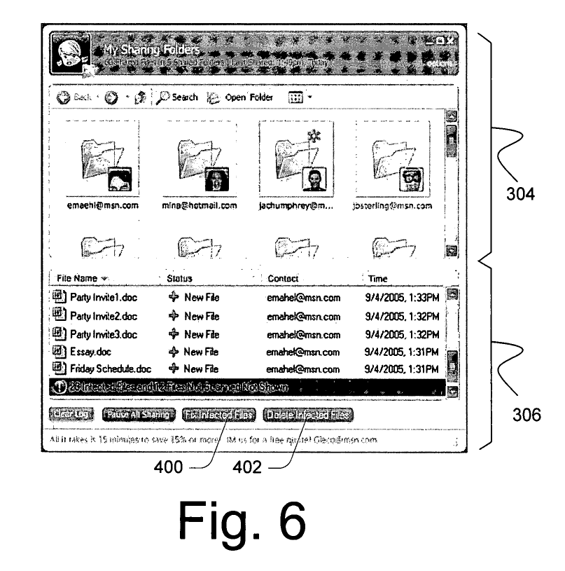

FIG. 6 illustrates the FIG. 3 user interface in which the secondary portion 306 indicates that the log contains some files that have been found to be infected, but that those particular infected files are not specifically shown in the view. In this instance, the user can quickly access or view the files by using the illustrated scroll bar and can then, if so desired, select a particular remedial action to be applied.

Exemplary System

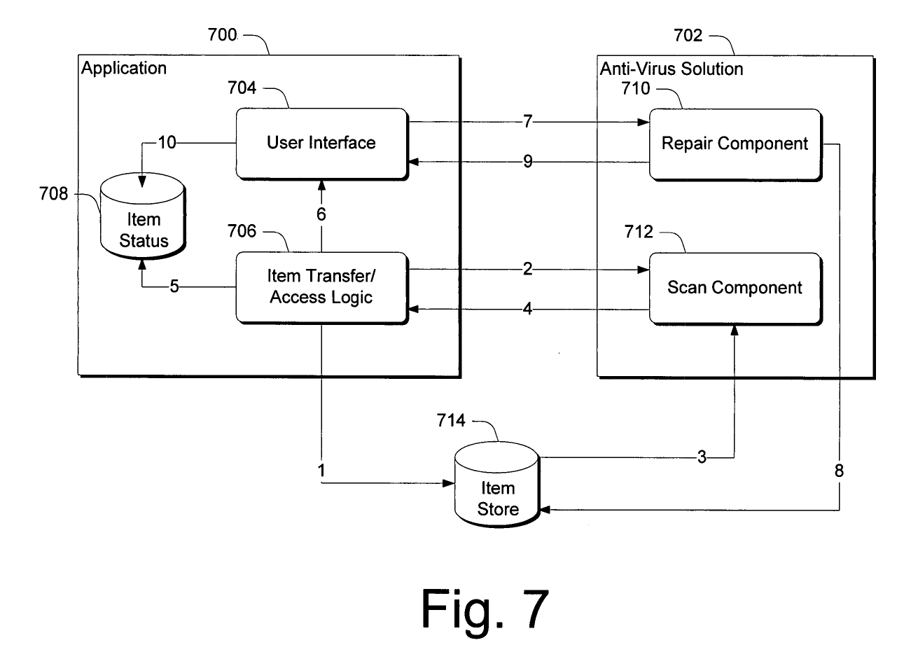

FIG. 7 illustrates an exemplary system in which the inventive principles can be utilized in accordance with one embodiment. Here, the system includes an application 700 and a so-called anti-virus solution 702. As noted above, application 700 can comprise any suitable type of application. In the context of the example given just above, the application can comprise a messenger application and, more particularly, the sharing folders feature.

In this particular example, application 700 includes a user interface component 704, such as the one shown and described above, an item transfer/access logic component 706 and an item status component 708.

Item transfer/access logic component 706 is configured to transfer or otherwise access items such as files. For example, in the context of the sharing folders application, component 706 transfers or accesses items in the form of files. In other contexts, such as when application 700 is instead a DLL, component 706 may be used to simply access items such as folders or files. Another example of item transfer/access logic is the file download logic in a browser, with its user interface counterpart being the file download status window or status user interface.

Of course, application 700 can contain other elements. However, for the sake of brevity, these have not been illustrated.

Item status component 708 allows the application to persistently store the anti-virus scanning status of its items, so that this status can be maintained, e.g. across applications or system restarts.

Anti-virus solution 702 includes a repair component 710 and a scan component 712. In practice, the repair component and scan component can utilize standard virus scanning and repair techniques. As such techniques will be known and appreciated by the skilled artisan, such are not described in detail here.

In this particular example, components 710, 712 can be invoked from the application through any existing mechanism offered by the underlying platform such as, for example, by calling a procedure that is part of a DLL, by running a process from the application, by calling into a COM interface, or by issuing an RPC call. The invocation of these components will typically have a number of arguments (e.g. to indicate what item needs to be scanned), and will return status information to the application. Note that in a particular embodiment, the scan component and the repair component may or may not be separate. In the latter case, the desired functionality can be specified by the application via one of the parameters.

Item store 714 comprises a store that is utilized to store items such as files and the like. The item store can be embodied in the file system or can comprise some other type of store. For example, such store may be the store used by an email client to keep received emails. In a particular embodiment, item store 714 and item status component 708 may or may not be separate.

The operation of the system of FIG. 7 is shown and represented by the numbered arrows that extend between the various components of the system. In this particular example, the operation is as follows.

First, the item transfer/access logic 706 adds a new item (at “1”) to the item store 714, or modifies one of the existing items. At this point, logic 706 may also notify the user interface 704 of the new or modified item. The user interface 704 can reflect the fact that the item has not yet been scanned (for instance, by using a different background color or an icon overlay). An example of this was provided above in FIG. 5.

Next, at “2”, the item transfer/access logic 706 requests a scan on the new or modified item by invoking the scan component 712 of the anti-virus solution 702. In practice, logic 706 passes as an argument the location of the item in the item store 714 (e.g. if the item is a file, then it passes the file path). In an alternate embodiment, item transfer/access logic 706 may pass a copy of the entire item when invoking the scan component 712.

The scan component, at “3”, scans the item to determine whether it is infected with a virus, is “clean”, or is in some intermediate state of varying potential for infection. Based on its scan, scan component 712 returns the scan status, at “4”, to the item transfer/access logic 706. Next, the item transfer/access logic 706 persists, at “5”, the item status in the item status store or component 708.

The item transfer/access logic 706 notifies the user interface component 704, at “6”, on the item status. Upon receipt of the notification, the user interface component 704 can or should reflect the new status of the item for the user (i.e. “clean”, “infected”, or varying level of potential for infection) by means of some type of visually displayed indicia, examples of which are provided above. For example, the status may be reflected by a different background color that encompasses the affected item, by an icon overlay, or an infection probability rating.

If or when the user notices that one or more items have been flagged as “infected”, the user has the option to either ignore this notification, fix the items, or delete the items. If the user chooses to either fix or delete the items by selecting one of the appropriate user interface elements (such as elements 400, 402 in FIG. 5), the user interface component 704 invokes, at “7”, the repair component 710 of the anti-virus solution 702, passing it as an argument the location of the item(s) to be fixed or deleted. The repair component 710 can then access item store 714 at “8” to fix or delete the items. Alternately or additionally, the application itself can delete the item if the user so chooses. Alternately or additionally, the user interface component 704 can invoke the repair component 710 by passing a copy of the item to be fixed, and the repair component can return a copy of the fixed item, or a status indicating that the item could not be fixed.

Upon completion of its task, the repair component 710 can return, at “9”the fix/delete status to the user interface component 704. The user interface component 704 can then update, at “10” the item status in the item status store 708 and reflect the new status visually for the user, thus providing feedback to the user that the item(s) has been fixed or deleted.

Note that at step 6 above, the user interface component 704 may not currently display when an infected item is detected. For instance, if the application is an email client, it may receive an infected email while the application user interface is minimized. In that case, an application-specific way can be used to attract the user's attention to the fact that infected items have been found. Such application-specific can include, by way of example and not limitation, the following. The application's icon can be changed to attract the user's attention and prompt him or her to open the user interface. Alternately or additionally, the application's user interface can be opened directly. Alternately or additionally, a balloon can be used to inform the user that the application has detected infected items.

In addition, in at least some embodiments, the application may selectively treat items based on a computed infection rating. For example, if infected, the application may block the item from being opened. In the case of files, the infected files could be locked by the application. If an infection probability is greater than an application-specific threshold, as determined by applying heuristic rules, the application could display a mild warning in its activity log. If a new virus has been identified after the item was scanned with an out-of-date anti-virus signature file, the item can be re-scanned.

In the sharing folders implementation shown in FIGS. 4-6 the system of FIG. 7 can operate in the following way.

In FIG. 4, the Sharing Window and the attached Sharing Log—the main user interface of Sharing Folders—looks clean and simple when the anti-virus solution has scanned all the incoming files and has found no infections. In FIG. 7 at “1”, the item transfer/access logic 706 adds a new item to the item store 714, or modifies one of the existing items.

At this point, the item transfer/access logic 706 notifies the user interface component 704 of the new or modified item and records it in the Sharing Log. Because the item has not yet been scanned, it can be highlighted in yellow and marked as “Waiting for Scan” as shown in FIG. 5. There can also be a small yellow shield icon to the left of the filename or some other type of visible indicia to provide the user with an indication of the scan waiting status.

The item transfer/access logic requests, at “2”, a scan on the new or modified item by invoking the scan component 712 of the anti-virus solution. To do so, it passes as an argument the file path of the file to be scanned.

The scan component 712 accesses the item at “3” and scans the item to determine whether it is infected with a virus, is “clean”, or could not be scanned at the moment. The scan component 712 then returns, at “4”, the scan status to the item transfer/access logic 706.

The item transfer/access logic 706 persists, at “5”, the item status in the item status component 708. The item transfer/access logic 706 next notifies, at “6” the user interface component 704 on the item's status. Upon receipt of the notification, the user interface component 704 can reflect the new status by means of a different background color (yellow for not scanned, red for infected), an icon instead of the file type icon, and text in the status column (“Waiting for Scan” or “Infected”), as shown in FIG. 5. Since, in this implementation, the Sharing Log displays a limited number of entries, FIG. 6 shows a special entry to catch any items that are no longer visible in the log.

When the user notices that one or more items have been flagged as “infected”, the user is provided, via the user interface, with the option to either ignore this notification, fix the items, or delete the items. The two “Fix Infected Files” and “Delete Infected Files” buttons in FIGS. 4-6 correspond respectively to the latter two choices. If the user chooses one of the latter two options, the user interface component 704 can invoke, at “7”, the repair component 710 of the anti-virus solution, passing it as an argument the location of the item(s) to be fixed or deleted. The repair component 710 can then access, at “8”, the item(s) of interest and fix or delete the item(s).

Upon completion, the repair component returns, at “9”, the fix/delete status to the user interface component 704. The user interface component 704 can then update, at “10” the item's status in the item status store 708 and reflect the new status visually by clearing the background colors and returning the status text to normal, or by marking the item as deleted in the log, thus providing feedback to the user that the item(s) have been fixed or deleted, respectively.

Accordingly, in this particular embodiment, the user interface is able to provide a visual indication of the anti-virus scanning status for the items displayed or logged by the messenger application. This indication allows the user to determine which items have been scanned, and whether the scanned items have been found to be free from infection, are believed to be infected, or have a varying probability of being infected. Further, this particular embodiment can provide a way for the user of the application to select how to resolve potential infections by allowing the user to either ignore the infection, delete the infected items, or ask the anti-virus scanner to fix the items by removing the infection. Moreover, this embodiment can provide a way for the application to chose how to selectively treat the files based on their level of infection or potential infection. In addition, this embodiment can provide a visual indication that an infection has been resolved, i.e. the infected items have been deleted or fixed.

Hence, this embodiment can provide a rich visual feedback to the user regarding the current status of the items that are being handled by the application. The user can tell at a glance what the anti-virus scanning status of the items is without having to switch to a different user interface. Further, this and other embodiments can provide a clear indication to the user of where the infection originated from. For example, if the application is a file transfer application, then the infection may have originated from one of the received files; for an email application, the infection may have originated in one of the received email messages; for a browser download window, the infection may have been caused by one of the downloaded files.

Further, providing a way to control the resolution of infections is completely integrated into the user interface of the application which, in the embodiments described above, is an application that is not primarily dedicated to anti-virus activities. In particular, this allows the user to easily disable the offending functionality (at least temporarily) or change their behavior to avoid future infections. For example, if the infection is pinpointed to downloading a file from a particular website, the user may want to avoid visiting that website in the future.

Exemplary Methods

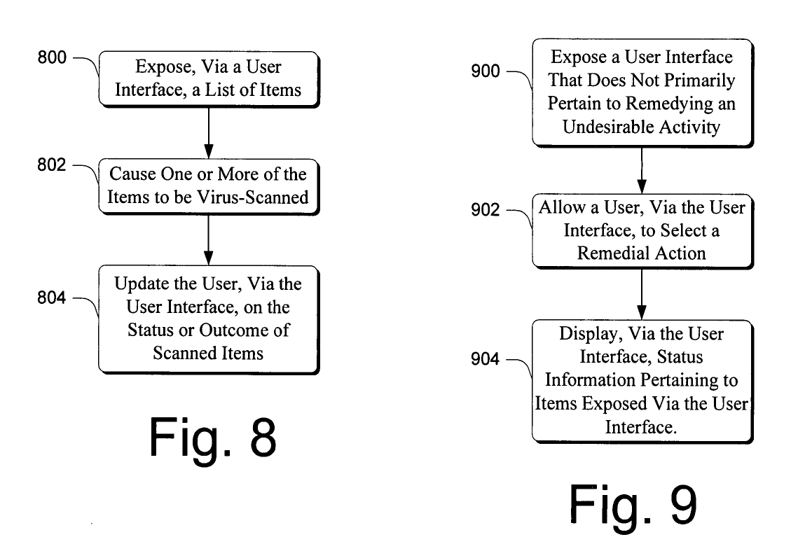

FIG. 8 is a flow diagram that describes steps in a method in accordance with one embodiment. The method can be implemented in connection with any suitable hardware, software, firmware or combination thereof. In at least one embodiment, the method is implemented in software.

Step 800 exposes, via a user interface, a list of items. Examples of user interfaces and items are given above. In at least one embodiment, the user interface comprises part of a software entity that does not primarily pertain to anti-virus scanning. Examples of such entities are given above. Step 802 causes one or more of the items to be virus-scanned. Examples of how this can be done are given above. Step 804 updates the user, via the user interface, on the status or outcome of scanned items. Again, examples of how this can be done are given above.

FIG. 9 is a flow diagram that describes steps in a method in accordance with one embodiment. The method can be implemented in connection with any suitable hardware, software, firmware or combination thereof. In at least one embodiment, the method is implemented in software.

Step 900 exposes a user interface that does not primarily pertain to remedying an undesirable activity that can be encountered via an application of which the user interface comprises a part. Examples of user interfaces and undesirable activities are given above. Step 902 allows a user, via the user interface, to select a remedial action that is to be performed relative to an undesirable activity that is encountered via the application. Examples of remedial actions are given above. Step 904 displays, via the user interface, status information pertaining to items that are exposed via the user interface. Examples of how this can be done are given above.

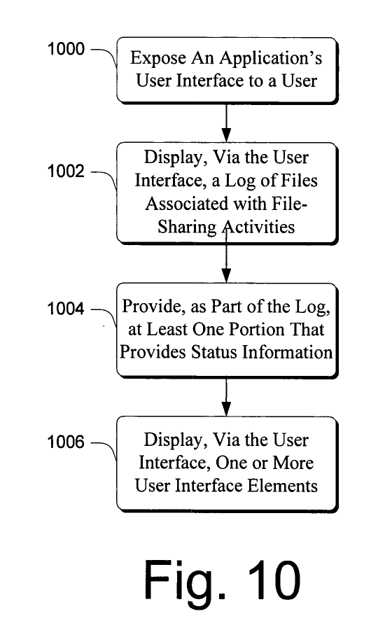

FIG. 10 is a flow diagram that describes steps in a method in accordance with one embodiment. The method can be implemented in connection with any suitable hardware, software, firmware or combination thereof. In at least one embodiment, the method is implemented in software.

Step 1000 exposes an application's user interface to a user. In at least one embodiment, the user interface comprises part of a file-sharing user interface. Examples of file-sharing user interfaces are given above. Step 1002 displays, via the user interface, a log of files associated with file-sharing activities. Examples of logs are given above. Step 1004 provides, as part of the log, at least one portion that provides status information that pertains to whether individual files have been virus-scanned and the status of any files that have been virus-scanned. Examples of how this can be done are given above. Step 1006 displays, via the user interface, one or more user interface elements that permit a user to select an action with regard to any files that have been scanned. Examples of user interface elements and actions that can be selected using the user interface elements are given above.

Other Areas of Applicability

As noted in the discussion of FIG. 1, the principles described in this document can be employed in a variety of contexts.

For example, an email client can display an infection status of email messages that are received in a mail visualization pane. For example, a user can look at their inbox and be able to see, at a glance, whether all of their incoming messages have been scanned and whether any of these messages has been found to be infected. Scanning of the messages may include both scanning the email body as well as any attachments to the message.

A browser download window can show the progress and history of the file downloads, and display an infection status for downloaded files.

A file open dialog can show the anti-virus scanning status of the files on disk and can thus offer the user a visual cue of whether it is safe to open the files from a given application. Since open file dialogs are generally shared among applications, this can provide uniform benefits to a large number of applications that would not have to be modified to include this anti-virus functionality.

An RSS aggregator (or any like application that subscribes to content feeds) can show the infection status of the feeds or particular files that it aggregates, and allow the user to clean files, block feeds, etc.

A photo-sharing, video-sharing, or music-sharing application can automatically block any respective photos, videos, or music content (whether downloaded or streamed) that are found to contain viruses.

A newsgroup reader application can scan the displayed postings to detect infected ones.

Conclusion

Various embodiments provide integrated solutions for detecting and treating undesirable activities. Detection and treatment solutions are integrated with software entities, such as applications, DLLs and the like, and provide status notifications for the user as to the status of the detection and treatment activities. In at least some embodiments, an integrated user interface is provided and gives the user the option to provide input and affect at least some of the treatment options.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A computer-implemented method comprising:
exposing, via a user interface comprised as part of a software entity that does not primarily pertain to anti-virus scanning, a list of items;
causing one or more of the items to be virus-scanned; and
updating the user, via the user interface, on the status or outcome of scanned items.

2. The method of claim 1, wherein the list comprises a log activity list.

3. The method of claim 1, wherein the items comprise files.

4. The method of claim 1, wherein the software entity comprises a software application.

5. The method of claim 1 further comprising providing, via said user interface, one or more user interface elements that allow a user to select a remedial action that is to be performed on one or more scanned items.

6. The method of claim 5, wherein one remedial action comprises attempting to fix an infected file.

7. The method of claim 5, wherein one remedial action comprises deleting an infected file.

8. A computer-implemented method comprising:
exposing a user interface that does not primarily pertain to remedying an undesirable activity that can be encountered via an application of which the user interface comprises a part;
allowing a user, via the user interface, to select a remedial action that is to be performed relative to an undesirable activity that is encountered via said application; and
displaying, via the user interface, status information pertaining to items that are exposed via the user interface.

9. The method of claim 8, wherein the application comprises a messenging application.

10. The method of claim 8, wherein the undesirable activity comprises one other than receiving virus-carrying content.

11. The method of claim 8, wherein the undesirable activity comprises receiving virus-carrying content.

12. The method of claim 8, wherein the act of displaying comprises displaying status information pertaining to the user's selection of a remedial action.

13. The method of claim 8, wherein at least some of the status information pertains to the undesirable activity.

14. The method of claim 8, wherein at least some of the status information does not pertain to the undesirable activity.

15. The method of claim 8 further comprising displaying said item, via the user interface, in a list of items.

16. A computer-implemented method comprising:
exposing an application's user interface to a user, the user interface comprising part of a file-sharing user interface;
displaying, via the user interface, a log of files associated with file-sharing activities;
providing, as part of the log, at least one portion that provides status information that pertains to whether individual files have been virus-scanned and the status of any files that have been virus-scanned; and
displaying, via the user interface, one or more user interface elements that permit a user to select an action with regard to any files that have been scanned.

17. The method of claim 16, wherein the application comprises a messenging application.

18. The method of claim 16, wherein the application does not comprise a messenging application.

19. The method of claim 16, wherein one action comprises attempting to fix an infected file.

20. The method of claim 16, wherein one action comprises deleting an infected file.
